(19) United States
(12) Patent Application Publication
(10) Pub. No.: US 2008/0095146 A1
(43) Pub. Date: Apr. 24, 2008

(54) Device For Tapping Useful Data From Multimedia Links In A Packet Network

(76) Inventor: Hermann Granzer, Pocking (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/660,227

(22) PCT Filed: Aug. 5, 2005
(86) PCT No.: PCT/EP05/53872

§ 371 Date: Feb. 15, 2007

(30) Foreign Application Priority Data
Aug. 20, 2004 (DE) 10 2004 040 482.8

(51) Int. Cl. H04L 12/66

(52) U.S. Cl. 370/352

(57) ABSTRACT

In one aspect, a device for lawful interception of multimedia links in a packet network, over which voice data and image data are transmitted separately is provided. The device includes a receiver unit that receives a image data from a transmit device, and a delay unit that routes the received image data with a delay to a receive device.

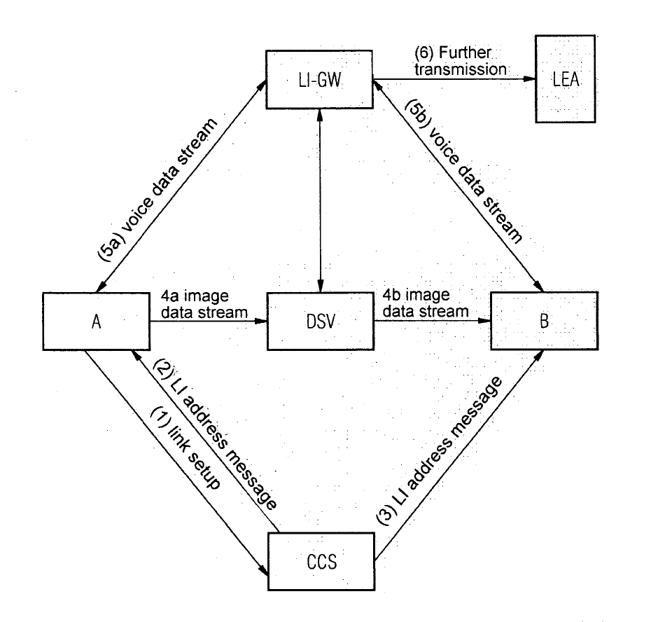

### CROSS REFERENCE TO RELATED APPLICATIONS

This application is the US National Stage of International Application No. PCT/EP2005/053872, filed Aug. 5, 2005 and claims the benefit thereof. The International Application claims the benefits of German application No. 102004040482.8 DE filed Aug. 20, 2004, both of the applications are incorporated by reference herein in their entirety.

### FIELD OF INVENTION

The present invention relates to a device for tapping useful data from multimedia links in a packet network.

### BACKGROUND OF INVENTION

With the increasing spread and use of data-based communication such as Voice-over-IP (VoIP) and Video-over-IP or Multimedia-over-IP (MoIP), regulatory and legislative measures are also increasing in significance. A current example of this is Lawful Interception (LI), referred to below by its abbreviation LI, which is taken to mean the (lawful) interception of telephone calls and also of VoIP (data calls).

This legally prescribed option for intercepting voice data is performed in classical telephone networks in TDM technology. In the packet network the voice data must be routed via a conventional interface into the TDM network where the interception is undertaken in a classical manner using a TDM loop in TDM technology. This means that initially a conversion of for example IP (Internet Protocol) to TDM must be undertaken. Here the tapped voice data is forwarded to the requesting bodies (LEAS, Law Enforcement Agencies), referred to below by their abbreviation LEA. In parallel to this a conversion back into the IP protocol is undertaken, via which the voice data is then routed to the called party.

In the case of video telephony in the packet network the problem which now arises is that of how to tap the mixed useful data stream now made up of voice data and image data. For implementing LI in the packet network it has been proposed that voice and images be separated and handled separately. To this end the voice data is routed out of the packet network via the TDM loop where it is tapped conventionally. The image data by contrast is routed directly via the packet network to the receiver, where the separated voice and image data must be merged again.

The separation in this case is undertaken in the terminal or in a device assigned to the terminal, either by creating two separate connections or by issuing two packet addresses within the framework of a single connection.

### SUMMARY OF INVENTION

However the special handling of the two useful data streams has one significant disadvantage. It means that the voice data is subject to an additional delay, especially as a result of the conversion from IP into TDM and back again. By contrast, the image data, which does not undergo this conversion, is thereby also not delayed additionally so that it arrives at the communication end point without any additional delay. Thus voice and image data may no longer be synchronized, the speech lags behind the lip movements for example. A retroactive synchronization in the terminal is not easily possible since the different data streams do not bear any secure time stamps. This means that the end subscriber can even detect that the call is being intercepted. In the “normal” case without LI, voice and image data arrive together at the terminal so that a lip synchronization can be undertaken here by the terminal.

An object of the invention is to specify a device which prevents the interception of communication data of multimedia connections being noticed by the end subscriber.

The object of the invention is achieved, starting from the features specified in the independent claims.

The advantage of the invention is that the image data is routed to the receiving subscriber via a delay device. In this case the delay can be embodied as a fixed value. Alternately the delay device can have an effective connection to the gateway via which the voice data stream is routed and converted. In this case the gateway notifies the delay unit about the magnitude of the delay to the voice data stream. This unit then dynamically modifies the relevant parameters and delays the image data stream accordingly.

The separation of voice data and image data can be undertaken in the terminal itself. This is not mandatory however. Thus the separation can take place in a device assigned to the terminal, such as a set-top box or a proxy server, or also in a media gateway for example.

The particular advantage of the invention can be seen as the fact that the invention is not restricted to a specific protocol or to voice connections/video connections. This means that any transmission protocol or other data connections can be used.

Advantageous developments of the invention are specified in the dependent claims.

### BRIEF DESCRIPTION OF THE DRAWINGS

The invention is explained in greater detail with reference to an exemplary embodiment shown in a FIGURE. Accordingly this shows a configuration with the aid of which the asynchronism between voice and image data stream is eliminated. To do this it is proposed in accordance with the invention to delay the image data stream artificially with the aid of a data stream delay unit.

### DETAILED DESCRIPTION OF INVENTION

In accordance with the FIGURE two terminals A, B are shown. The signaling between the two terminals passes via a Call Control Server CCS that can be embodied as an SIP Proxy, H.323 Gatekeeper or Media Gateway Controller. Furthermore the diagram includes a gateway LI-GW with LI functionality as well as the data stream delay unit DSV. Current gateways LI-GW have interfaces to the TDM world where the voice data is tapped. This means that an especially long delay occurs in the prior art. Gateway LI-GW does not however absolutely have to have TDM components and in this case is fully integrated into the IP world. This means that the voice data stream experiences a smaller delay, but this is still perceived by the receiving terminal because of the different paths of the two useful data streams.

It will now be assumed that terminal A wishes to establish a video call to terminal B. The call setup is signaled to the Call Control Server CCS (1). This now checks on the basis of a list whether one of the two terminals is to be intercepted in accordance with LI. If this is to be done, it transfers to the two terminals A, B information (2, 3) about the destination address to which the voice data stream is to be transmitted and the destination address to which the image data stream is to be transmitted.

The voice data stream is then transmitted to the gateway LI-GW (5a, 5b), the image data stream to the data stream delay unit DSV (4a, 4b). This is possible since the terminals support a separation of the voice data stream and the image data stream. In accordance with the present exemplary embodiment the separation can now be undertaken in the terminal either by creating two separate connections or by issuing two packet addresses within the framework of a single connection. The gateway LI-GW is effectively connected to the LEAs to which the intercepted voice data is transmitted.

The task of the data stream delay unit DSV is to delay the image data stream in such a way that the two separately routed data streams for voice and image data finally arrive at the receiving terminal simultaneously again. To this end the data stream delay unit DSV can either delay the image data stream with a fixed delay, or can also alternately maintain a separate communication with the gateway LI-GW in order to dynamically adapt the delay needed for the synchronization. If the delay then changes in the gateway LI-GW, e.g. because of a greater load or other related voice data encoding issues, the data steam delay unit DSV can be notified about this by the gateway LI-GW and adapt its delay immediately.

The dynamic adaptation of the delay can also be undertaken by another external measuring unit (e.g. QoS controller, which could also read out delay times from the routers).

1.-5. (canceled)

6. A device for lawful interception of multimedia links in a packet network, over which voice data and image data are transmitted separately, comprising:
a receiver unit that receives a image data from a transmit device; and
a delay unit that routes the received image data with a delay to a receive device.

7. The device as claimed in claim 6, wherein the transmit device controls the separation of voice data and image data.

8. The device as claimed in claim 6, wherein a device assigned to the transmit device controls the separation of voice data and image data.

9. The device as claimed in claim 6, wherein the delay is embodied as a fixed value.

10. The device as claimed in claim 9, wherein the transmit device controls the separation of voice data and image data.

11. The device as claimed in claim 9, wherein a device assigned to the transmit device controls the separation of voice data and image data.

12. The device as claimed in claim 6, wherein the delay is embodied as a variable value able to be influenced by a gateway or also by an external measuring unit.

13. The device as claimed in claim 12, wherein the transmit device controls the separation of voice data and image data.

14. The device as claimed in claim 12, wherein a device assigned to the transmit device controls the separation of voice data and image data.
